(19) United States
(12) Patent Application Publication
(10) Pub. No.: US 2014/0031108 A1
(43) Pub. Date: Jan. 30, 2014

(54) Gaming Machines And Gaming Systems Having Impact Detection And Deterrence Responses

(71) Applicant: WMS GAMING INC., Waukegan, IL (US)

(72) Inventors: Goran Popovic, Chicago, IL (US); Sean Kelly, Skokie, IL (US)

(73) Assignee: WMS GAMING INC., Waukegan, IL (US)

(21) Appl. No.: 13/769,528

(22) Filed: Feb. 18, 2013

Related U.S. Application Data
(60) Provisional application No. 61/675,872, filed on Jul. 26, 2012.

(51) Int. Cl. G07F 17/32

(52) U.S. Cl. CPC G07F 17/3241
USPC 463/27; 463/31; 463/25; 463/40

(57) ABSTRACT

According to one aspect of the present invention, a gaming terminal includes one or more output devices, one or more sensors, and one or more processors in communication with the one or more output devices and the one or more sensors. The one or more sensor devices are configured to measure an impact on the gaming terminal and generate an impact signal indicative of the measured impact. The one or more processors being operable to receive the impact signal from the one or more sensors, determine a response from a plurality of potential responses based on the impact signal, and cause the one or more output devices to provide at least one of an audio output and a visual output according to the determined response.

### CROSS-REFERENCE To RELATED APPLICATIONS

This application claims the benefit of and priority to U.S. Provisional Patent Application No. 61/675,872, titled “Gaming Machines And Gaming Systems Having Impact Detection And Deterrence Responses” and filed on Jul. 26, 2012, which is incorporated herein by reference in its respective entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to wagering game terminals and, more particularly, to wagering game machines and wagering game systems having impact detection and deterrence responses.

### BACKGROUND OF THE INVENTION

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing terminals and the expectation of winning each terminal is roughly the same (or believed to be the same), players are most likely to be attracted to the more entertaining and exciting terminal. As a result, wagering game terminal operators strive to employ the most entertaining and exciting terminals available, since such terminals attract frequent play and provide increased profitability for the operators. Consequently, wagering game terminals have added increasingly advanced and sophisticated features over the years in terms of their operational and display capabilities.

Over time, gaming terminals experience varying levels of wear due, in part, to normal use conditions and, in part, due to harsh handling by players. For example, gaming terminals can be an easy target for excited players to intentionally or unintentionally hit with fists, feet, ashtrays, glasses, or beer bottles. Additionally, players and thieves may attempt to cheat by damaging aspects of a gaming terminal such as, for example, a security door or bill validator. As a result, gaming terminals require service and maintenance to repair or maintain gaming terminals in good working condition at considerable expense to the operators and/or suppliers of the gaming terminals.

### SUMMARY OF THE INVENTION

According to one aspect of the present invention, a gaming terminal includes one or more output devices, one or more sensors, and one or more processors in communication with the one or more output devices and the one or more sensors. The one or more output devices are configured to provide at least one of an audio output and a visual output to a user of the gaming terminal. The one or more sensor devices are configured to measure an impact on the gaming terminal and generate an impact signal indicative of the measured impact. The one or more processors being operable to receive the impact signal from the one or more sensors, determine a response from a plurality of potential responses based on the impact signal, and cause the one or more output devices to provide at least one of the audio output and the visual output according to the determined response.

According to another aspect of the present invention, a method of detecting and responding to an impact on a gaming terminal includes detecting, by one or more sensor devices, an impact on a gaming terminal and determining, by one or more processors, one or more characteristics of the detected impact. The method further includes comparing, by at least one of the one or more processors, the one or more characteristics to one or more fault criteria. The method also includes determining, by at least one of the one or more processors, a response from a plurality of potential responses based on the comparison of the one or more characteristics to the one or more fault criteria and providing, via one or more output devices, the determined response to a player of the wagering game.

According to another aspect of the present invention, a gaming system includes a gaming terminal and a remote server. The gaming terminal includes one or more sensor devices configured to measure an impact on the gaming terminal and generate an impact signal indicative of the measured impact, and one or more processors in communication with the one or more sensor devices. The one or more processors are operable to receive the impact signal from the one or more sensors, determine a response from a plurality of potential responses based on the impact signal, and cause the determined response to be provided to a player of the gaming terminal. The remote server is operable to receive information based on the impact signal from the gaming terminal.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal.

FIG. 2 is a schematic view of a gaming system.

FIG. 3 is an image of an exemplary basic-game screen of a wagering game displayed on a gaming terminal, according to an embodiment of the present invention.

FIG. 4 is a side cross-sectional view of the free-standing gaming terminal of FIG. 1.

FIG. 5 is an image of an exemplary game screen displaying a response to a detected impact in accord with at least some aspects of the disclosed concepts.

FIG. 6 is an image of an exemplary game screen displaying a response to a detected impact in accord with at least some aspects of the disclosed concepts.

FIG. 7 is an image of an exemplary game screen displaying a response to a detected impact in accord with at least some aspects of the disclosed concepts.

FIG. 8 is an image of an exemplary game screen displaying a response to a detected impact in accord with at least some aspects of the disclosed concepts.

FIG. 9 is an image of an exemplary wagering game screen displaying a response to a detected impact in accord with at least some aspects of the disclosed concepts.

FIG. 10 is an image of an exemplary game screen displaying a response to a detected impact in accord with at least some aspects of the disclosed concepts.

FIG. 11 is an image of an exemplary game screen displaying a response to a detected impact in accord with at least some aspects of the disclosed concepts.

FIG. 12 is an image of an exemplary game screen displaying a response to a detected impact in accord with at least some aspects of the disclosed concepts.

FIG. 13 is an image of an exemplary game screen displaying a response to a detected impact in accord with at least some aspects of the disclosed concepts.

FIG. 14 is an image of an exemplary game screen displaying a response to a detected impact in accord with at least some aspects of the disclosed concepts.

FIG. 15 is an image of an exemplary game screen displaying a response to a detected impact in accord with at least some aspects of the disclosed concepts.

FIG. 16 is an image of an exemplary game screen displaying a response to a detected impact in accord with at least some aspects of the disclosed concepts.

FIG. 17 is an image of an exemplary game screen displaying a response to a detected impact in accord with at least some aspects of the disclosed concepts.

FIG. 18 is an image of an exemplary game screen displaying a response to a detected impact in accord with at least some aspects of the disclosed concepts.

FIG. 19 is an image of an exemplary game screen displaying a response to a detected impact in accord with at least some aspects of the disclosed concepts.

FIG. 20 is an image of an exemplary game screen displaying a response to a detected impact in accord with at least some aspects of the disclosed concepts.

FIG. 21 is an image of an exemplary game screen displaying a response to a detected impact in accord with at least some aspects of the disclosed concepts.

FIG. 22 is an image of an exemplary game screen displaying a response to a detected impact in accord with at least some aspects of the disclosed concepts.

FIG. 23 is a flowchart for an algorithm that corresponds to instructions executed by a controller in accord with at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

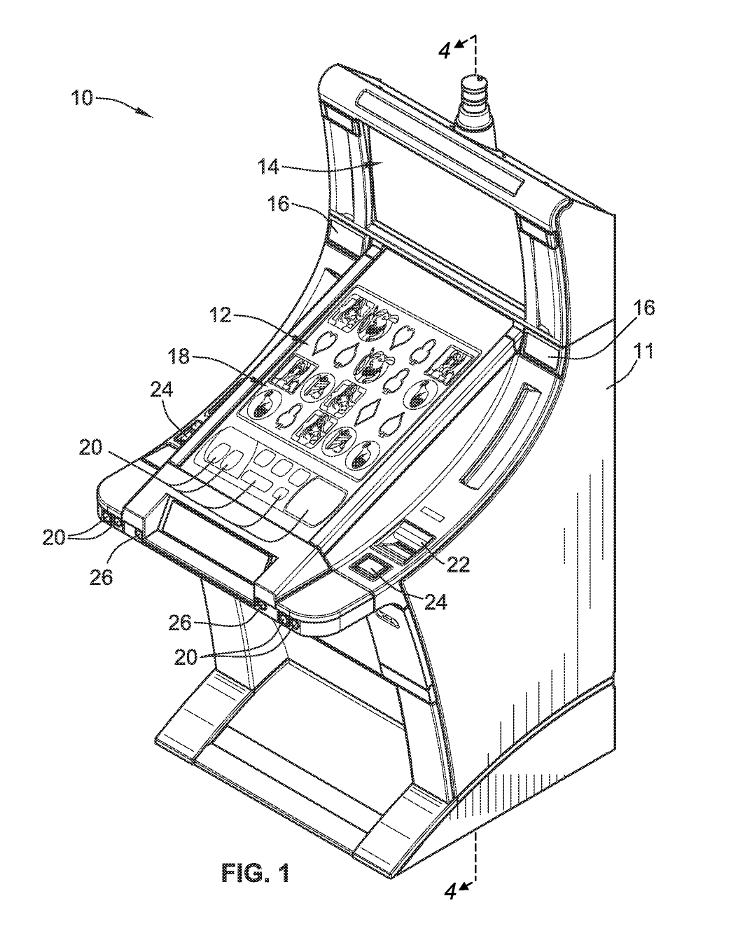

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0069160 and US2010/0234099, which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

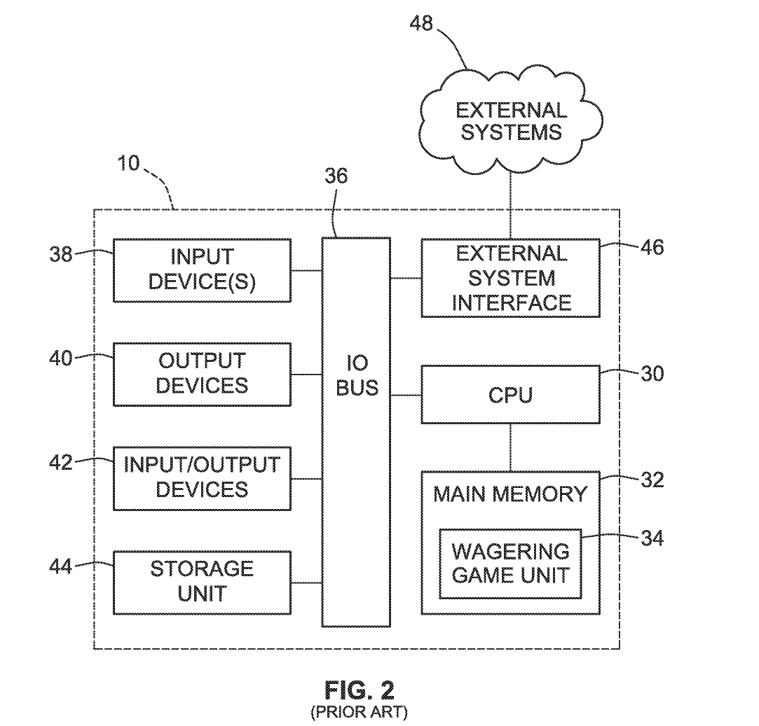

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

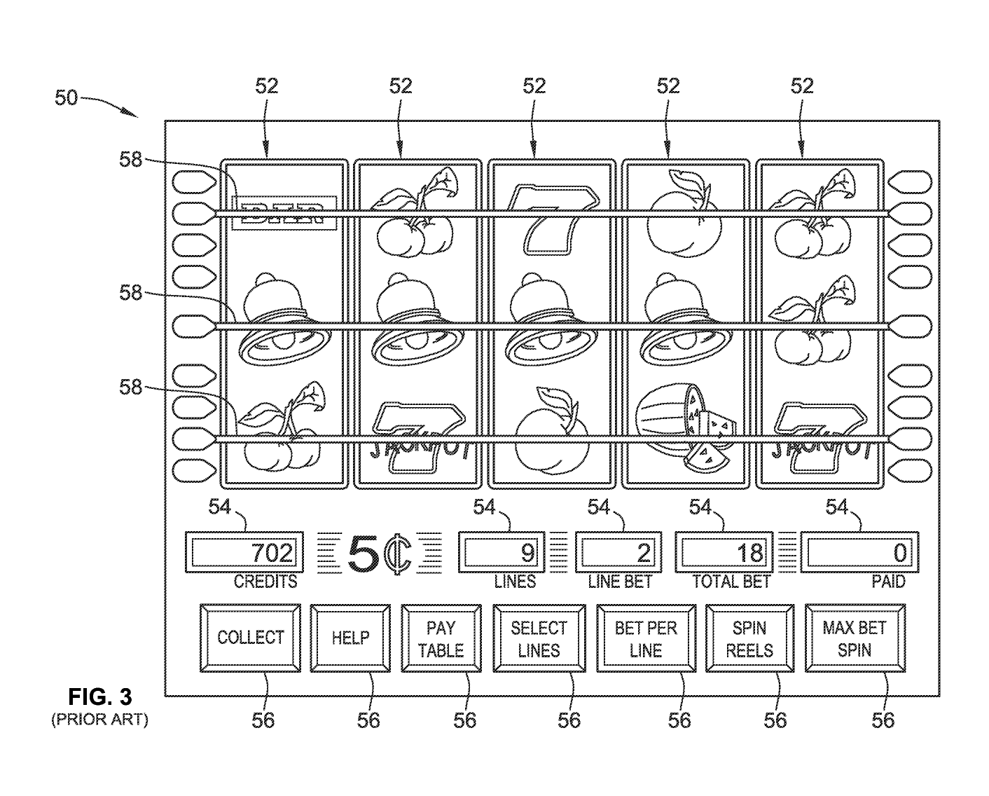

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

Over time, the gaming terminal 10 will experience varying levels of wear, in part, due to normal use conditions and, in part, due to harsh handling by players. For example, gaming terminals can be an easy target for excited players to intentionally or unintentionally hit with fists, feet, ashtrays, drink glasses, or beer bottles. In many instances, players may not even realize they are harshly handling a gaming terminal. In other instances, players and thieves may attempt to cheat by damaging features of a gaming terminal 10 such as, for example, a security door or a bill validator.

It has been found that players are less likely to handle a gaming terminal 10 harshly when the player is made aware that his or her actions are being monitored and/or that his or her actions are potentially hazardous to a gaming terminal. Accordingly, to mitigate harsh handling and provide enhanced security, the gaming terminal 10 advantageously includes features for monitoring and apprizing players of a harsh handling event (e.g., an impact) on the gaming terminal 10.

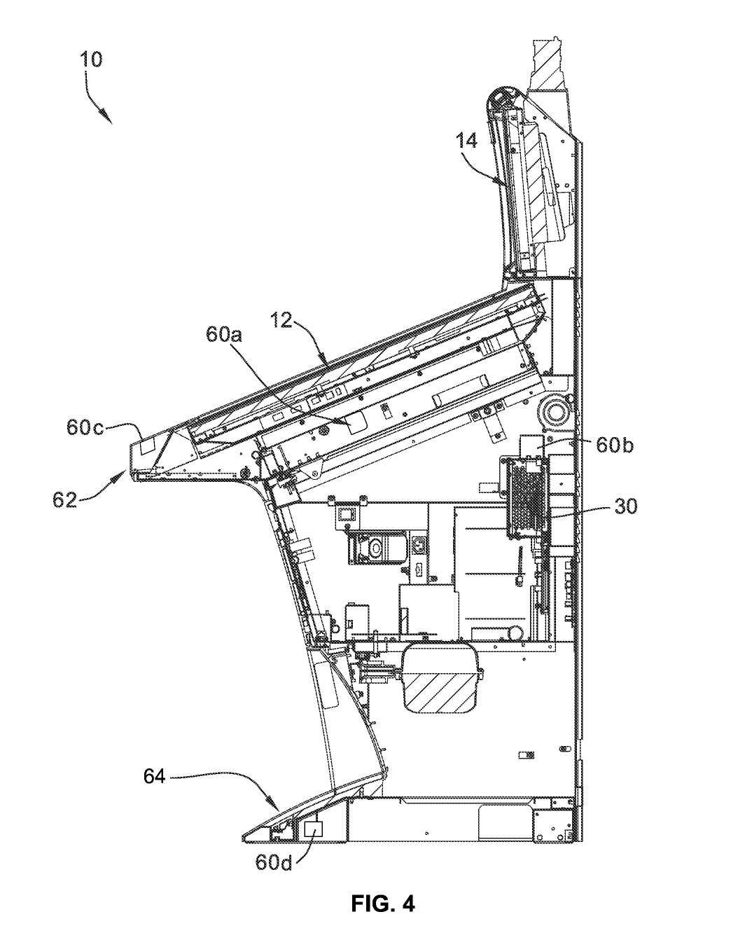

In particular, the gaming terminal 10 includes one or more sensors configured to measure an impact or an external force on the gaming terminal 10. The one or more sensors can be disposed within (e.g., embedded in), coupled to, and/or located near various components of the gaming terminal 10 to measure the effect of an impact or external force at various locations within the gaming terminal 10. In the exemplary embodiment illustrated in FIG. 4, a first sensor 60a is coupled to the primary display 12, a second sensor 60b located near the CPU 30, a third sensor 60c disposed in hand rest portion 62 of the gaming terminal 10, and a fourth sensor 60d disposed in a foot rest portion 64 of the gaming terminal 10; however, it should be understood that a sensor can be disposed within (e.g., embedded), coupled to, or located near any other feature of the gaming terminal 10. It should also be understood that while the embodiment illustrated in FIG. 4 includes four sensors 60a-d, any other number of sensors can be provided within the gaming terminal 10.

The one or more sensors 60a-d can include any device suitable for transducing an impact or an external force on the gaming terminal 10 into an impact signal indicative of the impact or external force such as, for example, an accelerometer, a pressure sensor, a piezoelectric sensor, a strain gauge, a force gauge, a tactile sensor, combinations thereof, and/or the like. In one exemplary implementation, the sensors 60a-d can include an accelerometer configured to generate an impact signal indicative of a g-force measurement in response to an impact on the gaming terminal 10.

The sensors 60a-d are communicatively coupled to the CPU 30 (e.g., via wired or wireless connectivity features). The CPU 30 is configured to process the impact signal from at least one of the sensors 60a-d to determine whether and/or how to respond to the detected impact or external force on the gaming terminal 10. For example, according to some aspects of the present disclosure, the CPU 30 can process an impact signal received from the sensors 60a-d to determine one or more characteristics of the impact signal using one or more algorithms, neural networks, and/or other mathematical models stored in the memory 32. The one or more characteristics of an impact signal can include, but are not limited to, one or a combination of a magnitude of an impact, a duration of an impact, a frequency of successive impacts, a location of an impact, a direction or an angle of incidence of an impact relative to a sensor, and any other value that can be derived from an algorithm, a neural network, or a mathematical model. The one or more characteristics of an impact signal can be considered a signature of the impact signal.

The CPU 30 can compare the one or more characteristics of the impact signal to one or more fault criteria stored in the memory 32. The one or more fault criteria can include, for example, one or more threshold values, one or more ranges of threshold values, and/or one or more predetermined impact signatures. Based on the comparison of the one or more characteristics and the one or more fault criteria, the CPU 30 can determine whether a response to the detected impact should be provided to the player, determine a response from a plurality of potential responses stored, for example, in the memory 32, and cause the determined response to be provided to the player, for example, via the one or more output devices (e.g., the primary display 12, the secondary display 14, and the one or more audio speakers 16).

According to some aspects, the one or more fault criteria can be determined based on known properties and characteristics of the features of the gaming terminal 10 (e.g., impact resistance values, tensile strength values, material breakpoints, stress limits, values determined by a Charpy impact test or an Izod impact strength test, etc.). For example, the one or more fault criteria can include a threshold value based on a known impact resistance value of the materials forming the primary display 12. According to other aspects, the one or more fault criteria can be determined experimentally from impact signal information obtained while operating a gaming terminal 10 under normal operating conditions and while intentionally subjecting the gaming terminal 10 to impacts representative of various harsh handling conditions. As such, fault criteria can be determined for a wide variety of potential conditions that a gaming terminal 10 may encounter when deployed in a casino or other environment. Additionally, fault criteria may optionally also be determined for normal use conditions as well.

The plurality of potential responses can include communications, messages, or other indications provided to the player via the one or more output devices. For example, the potential responses can include an audio output via the one or more audio speakers 16 and/or a visual output via the primary display 12 or the secondary display 14. Additionally, it is contemplated that, according to some embodiments, the gaming terminal 10 or a gaming chair (not shown) associated with the gaming terminal 10 can additionally or alternatively include an emotive lighting assembly for conveying a response to the player. It is further contemplated that, according to some embodiments, the gaming terminal 10 and/or an associated gaming chair can include one or more haptic and/or thermal actuators in communication with the CPU 30 for conveying a response to a player. Non-limiting examples of gaming systems including haptic and/or thermal actuators are disclosed in co-pending U.S. patent application Ser. No. 13/477,704 filed on May 22, 2012, which is incorporated herein by reference in its entirety. Accordingly, the potential responses can include audio messages, text-based messages, graphics, lighting patterns, tactile sensations or patterns, thermal sensations or patterns, combinations thereof, and/or the like.

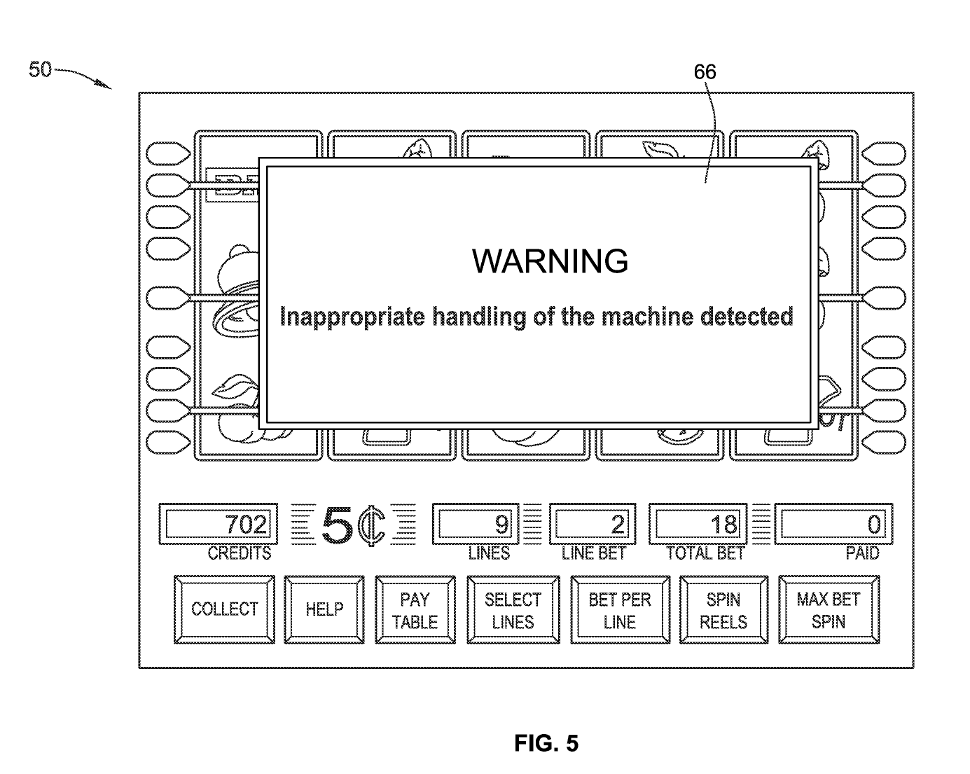

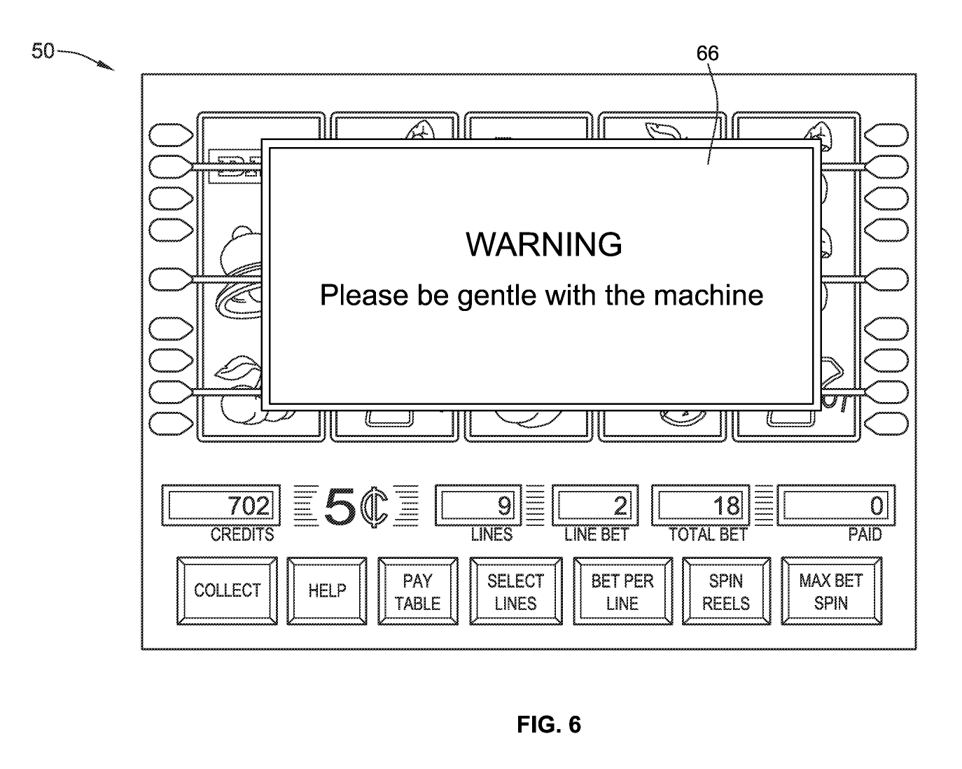

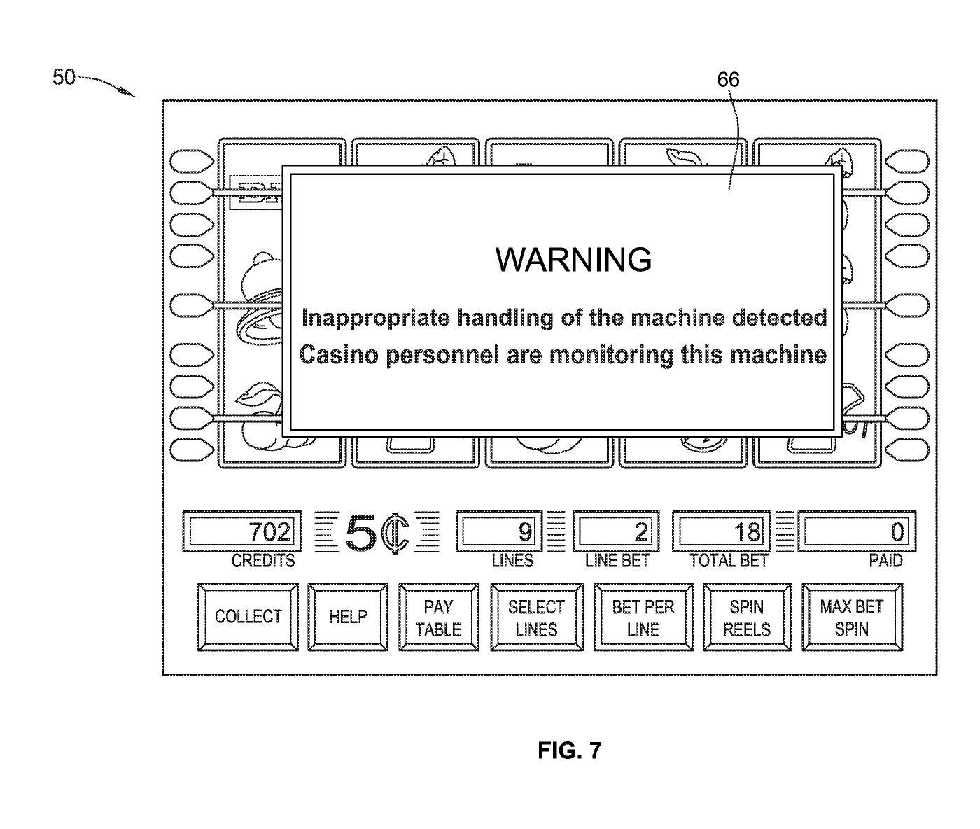

According to some embodiments, the plurality of potential responses can notify the player that a harsh handling event was detected, request that the player cease from further harsh handling of the gaming terminal 10, and/or inform the player that his or her actions are being monitored. For example, FIG. 5 illustrates an exemplary wagering game screen 50, displayed on the primary display 12, including a response 66 indicating that “Harsh Handling Has Been Detected.” As another example, FIG. 6 illustrates an exemplary wagering game screen 50, displayed on the primary display 12, including a response 66 requesting that the player “Please be gentle with the machine.” In still another example, FIG. 7 illustrates an exemplary wagering game screen 50, displayed on the primary display 12, including a response 66 warning the player that his or her actions are being monitored (e.g., by casino personnel). Receiving such messages, a player becomes aware that he or she has harshly handled a gaming terminal 10 and his or her actions are being monitored. As a result, the likelihood that the player will further harshly handle a gaming terminal 10 is advantageously mitigated.

According to some embodiments, the plurality of potential responses can include details specific to a particular harsh handling event. For example, the plurality of potential responses can include one or more messages indicating the location of an impact on the gaming terminal 10, the magnitude of an impact on the gaming terminal 10, the duration of an impact on the gaming terminal 10, the type of object that impacted the gaming terminal 10, the number of times an impact has been detected 10, and/or any other information that can be derived from the impact signals received by the CPU 30. By providing specific information about an impact, the player may be better able to avoid repeating the same mistake twice. Moreover, the player may be even less likely to harshly handle a gaming terminal 10 when the player believes that his or her actions are being monitored with a greater level of precision.

In some aspects, the CPU 30 can determine the location of an impact by analyzing the impact signals received from the one or more sensors 60a-d. For example, if an impact is detected by only one sensor of a plurality of sensors, the CPU 30 can determine that the impact occurred at a location nearer to the sensor that detected the impact than the sensor(s) that did not detect the impact. As another example, if an impact is detected by the sensor 60a and the sensor 60b, and the magnitude of the impact detected at sensor 60a is greater than the magnitude of the impact detected at sensor 60b (taking into consideration expected damping due to structural features of the gaming terminal 10), then the CPU 30 can determine that the impact occurred at a location nearer to the sensor 60a than the sensor 60b. As still another example, the CPU 30 can determine the location of an impact where the one or more fault criteria was determined by experimentally subjecting a gaming terminal to impacts at different locations on the gaming terminal (e.g., a signature of an impact signal can be compared to one or more predetermined signatures experimentally determined from impacts at different locations on the gaming terminal).

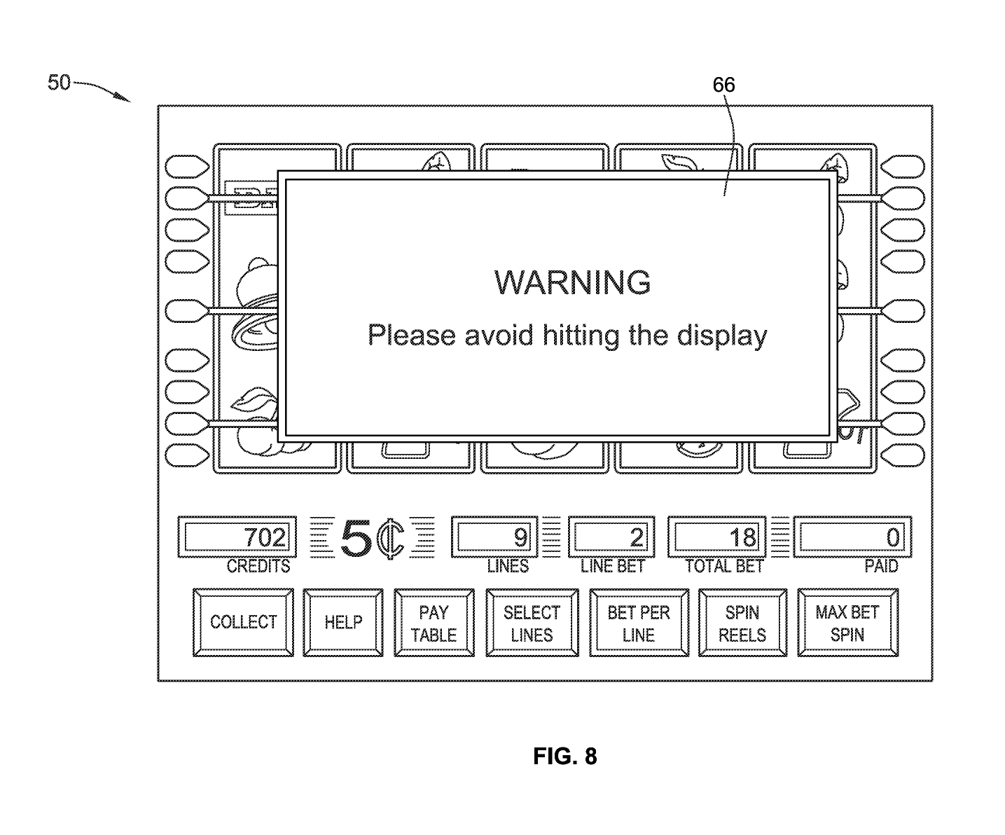

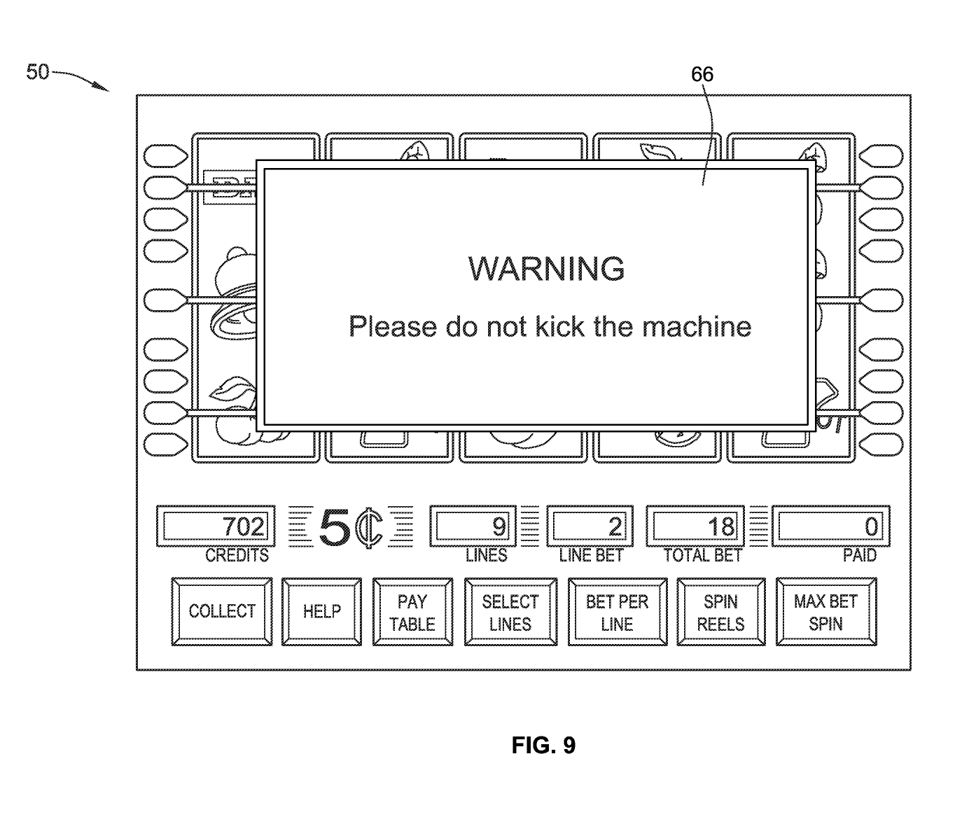

FIGS. 8-9 illustrate exemplary wagering game screens 50, displayed on the primary display 12, including responses that provide an indication as to the location of an impact on the gaming terminal 10. FIG. 8 illustrates an exemplary response 66 to an impact to the primary display 12 as indicated by the message, “Please avoid hitting the display.” FIG. 9 illustrates an exemplary response 66 to an impact to the foot rest portion 64 of the gaming terminal 10 as indicated by the message, “Please do not kick the machine.” A player may not have even realized that the player hit the primary display 12 or kicked the foot rest portion 64 of the gaming terminal 10. By providing the player with specific information as to the location of an impact, the player is more likely to avoid repeating an unintentional impact on the gaming terminal 10.

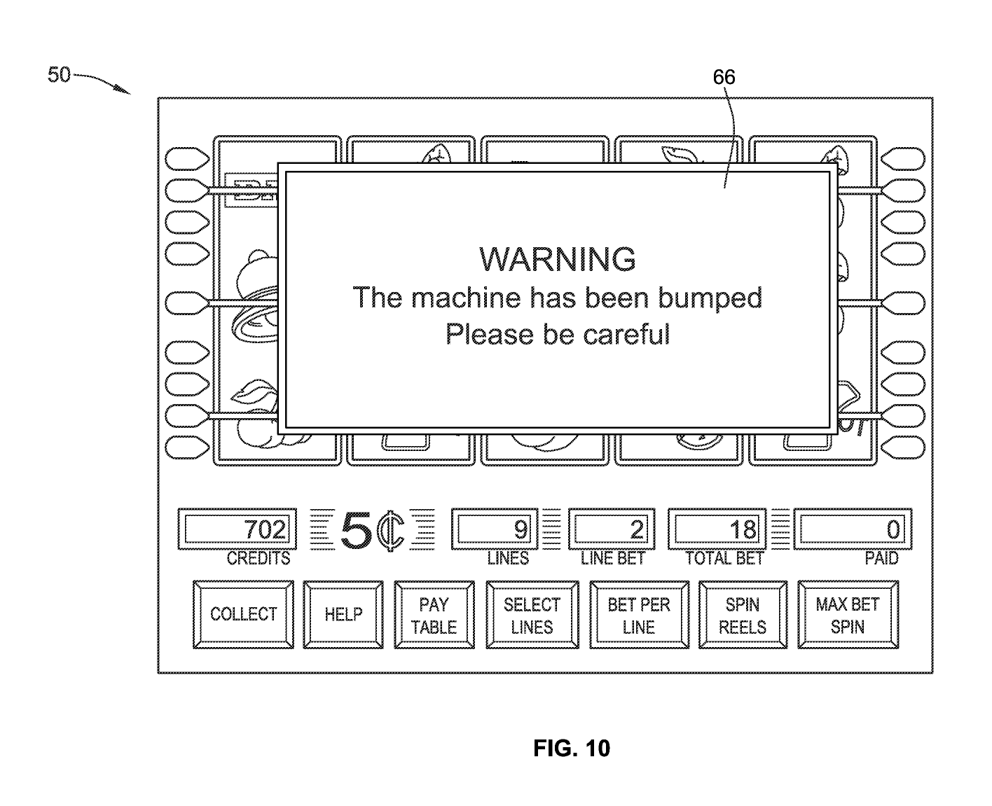

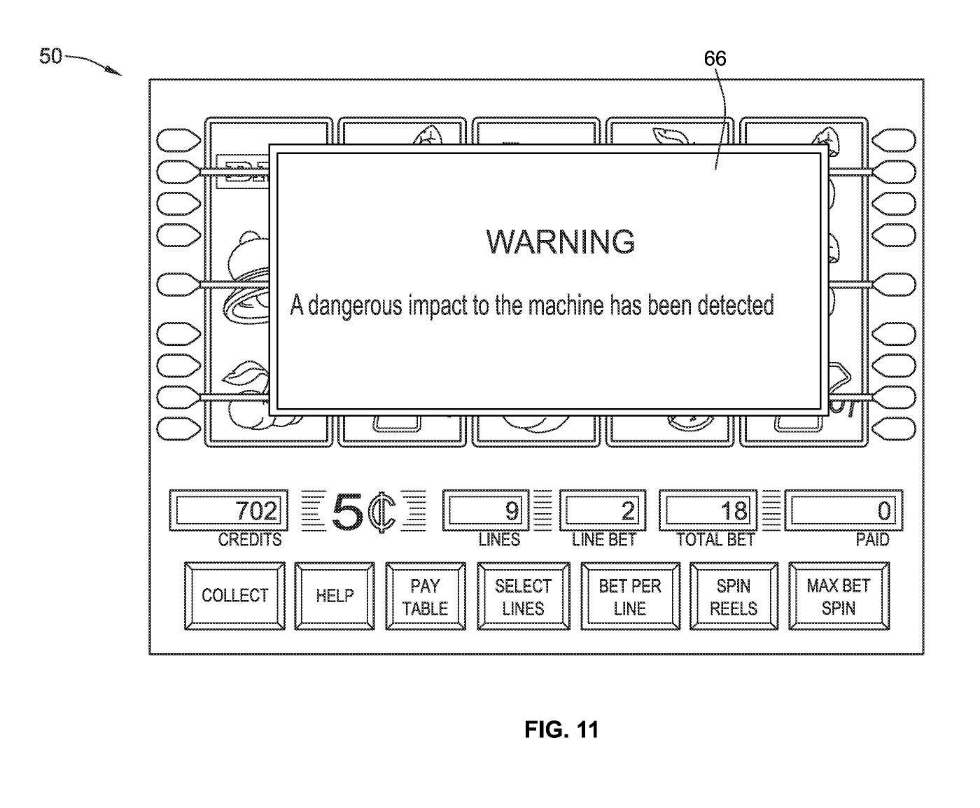

FIGS. 10-11 illustrate exemplary wagering game screens 50, displayed on the primary display 12, including responses that provide an indication as to the magnitude of an impact on the gaming terminal 10. FIG. 10 illustrates an exemplary response 66 to an impact having a low magnitude by indicating that “The machine has been bumped, please be careful.” FIG. 11 illustrates an exemplary response 66 to an impact having a greater magnitude by indicating that “A dangerous impact to the machine has been detected.” As will be described below, the responses may progressively increase in severity based on the magnitude of the detected impact.

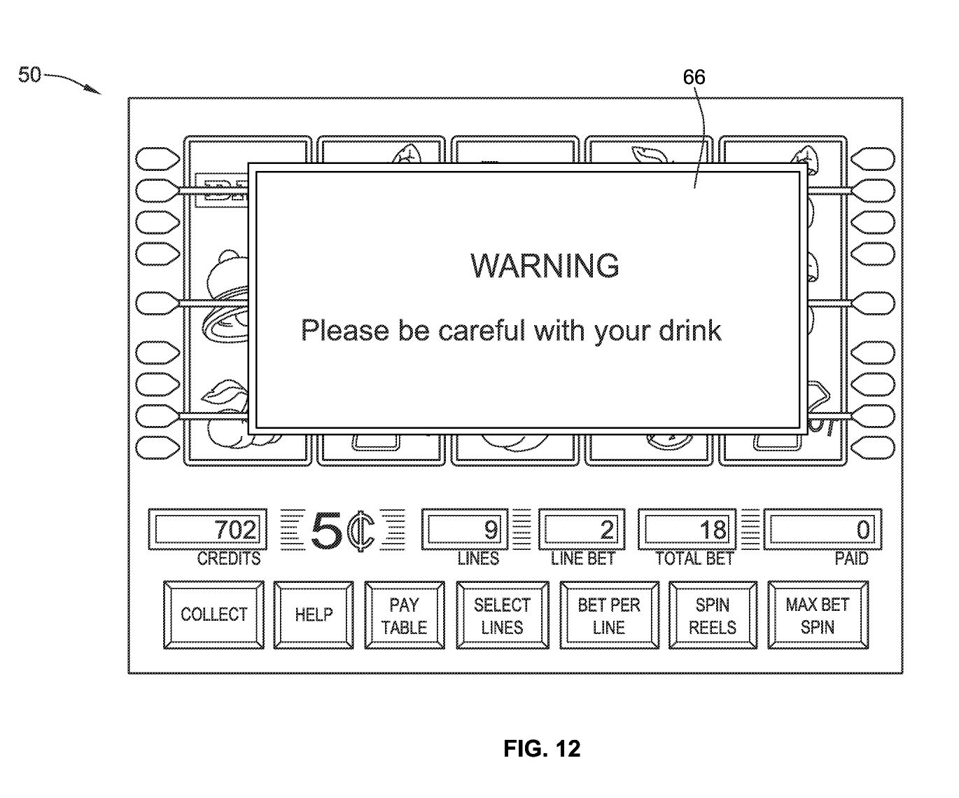

FIG. 12 illustrates an exemplary wagering game screen 50, displayed on the primary display 12, including a response 66 that provides an indication as to the type of object that impacted the gaming terminal 10. In particular, FIG. 12 illustrates an exemplary response 66 to an impact from a drink glass, indicating “Please be careful with your drink.” The CPU 30 may determine the type of object that impacted the gaming terminal 10, for example, where the one or more fault criteria was determined by experimentally subjecting a gaming terminal to impacts from different types of objects (e.g., a signature of an impact signal can be compared to one or more predetermined signatures experimentally determined from known impacts of different types of objects).

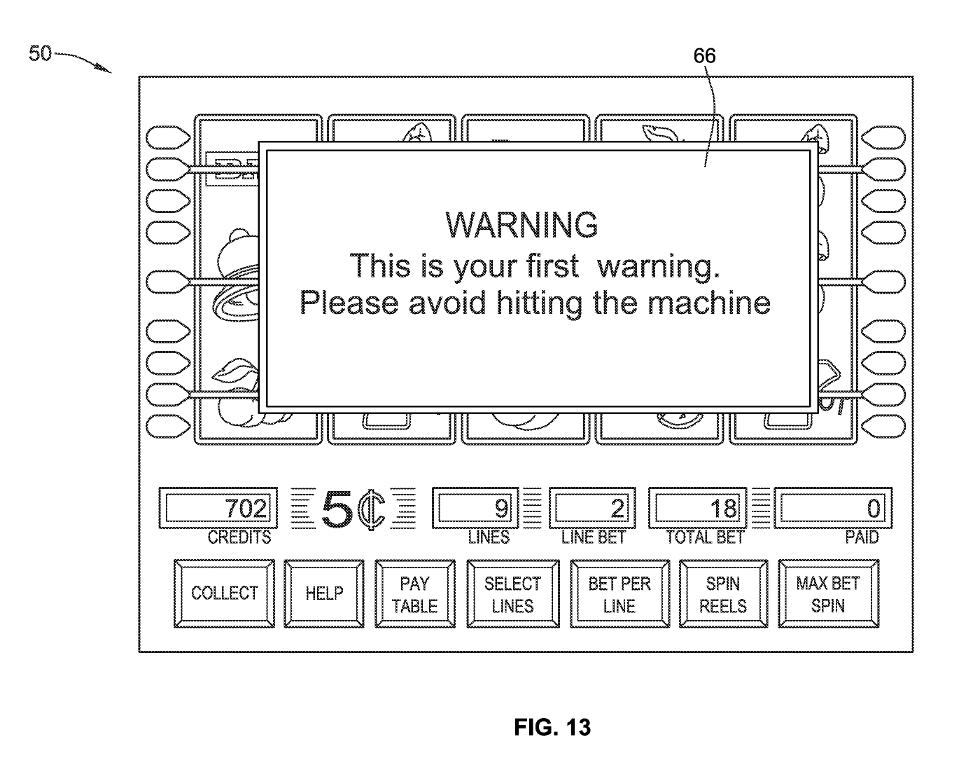

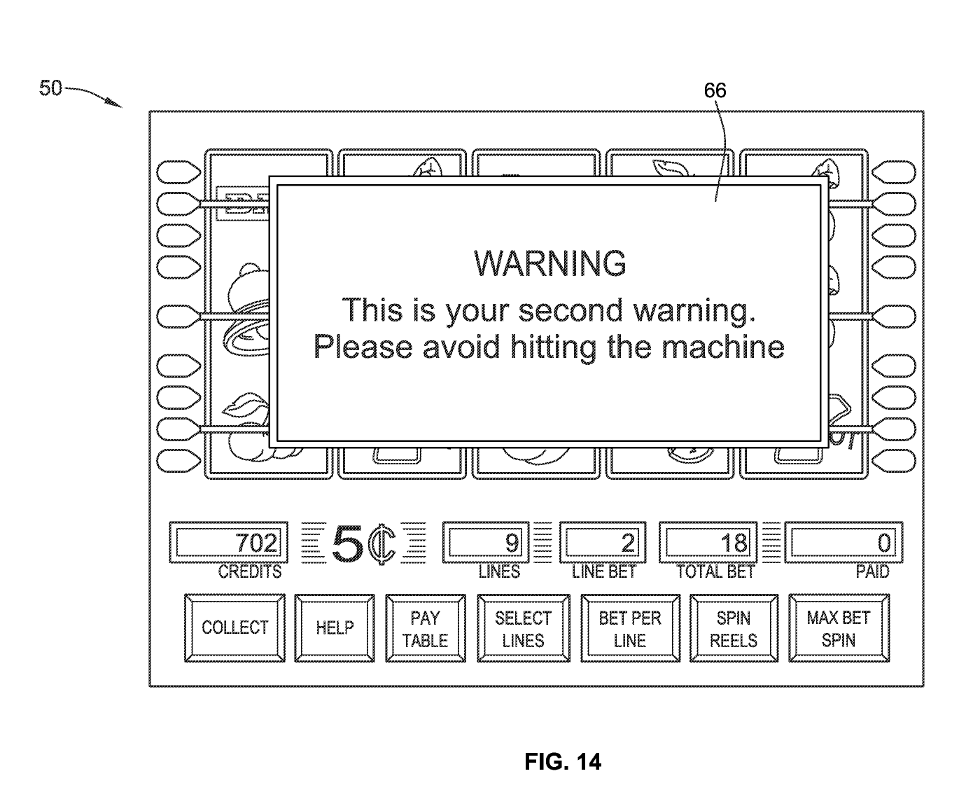

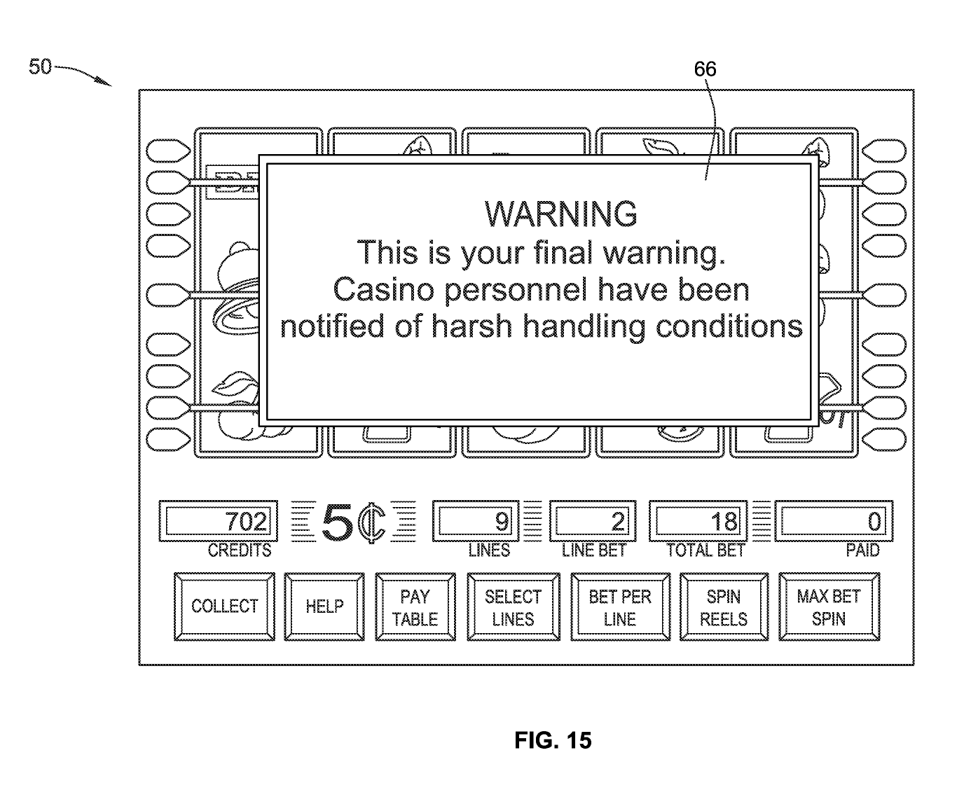

FIGS. 13-15 illustrate exemplary wagering game screens 50, displayed on the primary display 12, including responses that provide an indication as to the number of impacts on the gaming terminal 10 (e.g., over a particular period of time or a particular gaming session). FIG. 13 illustrates an exemplary response 66 to a first impact on the gaming terminal 10, FIG. 14 illustrates an exemplary response 66 to a second impact on the gaming terminal 10, and FIG. 15 illustrates an exemplary response 66 to a third impact on the gaming terminal 10. As will be described below, the responses may increase in severity for each successive impact on the gaming terminal 10.

According to some embodiments, the plurality of potential responses can include an indication of player information obtained, for example, via the information reader 24. The information reader 24 is preferably located on the front of the housing 11 and may take on many forms such as a ticket reader, card reader, bar code scanner, wireless transceiver (e.g., RFID, Bluetooth, etc.), biometric reader, or computer-readable-storage-medium interface. Information may be transmitted between a portable medium (e.g., ticket, voucher, coupon, casino card, smart card, debit card, credit card, etc.) and the information reader 24 for accessing an account associated with cashless gaming, player tracking, game customization, saved-game state, data transfer, and casino services as more fully disclosed, for example, in U.S. Patent Application Publication No. 2003/0045354, entitled “Portable Data Unit for Communicating with Gaming Machine Over Wireless Link,” which is incorporated herein by reference in its entirety. The account may be stored directly on the portable medium, or at an external system 46 (see FIG. 2) as more fully disclosed, for example, in U.S. Pat. No. 6,280,328, to Holch et al., entitled “Cashless Computerized Video Game System and Method,” which is incorporated herein by referenced in its entirety.

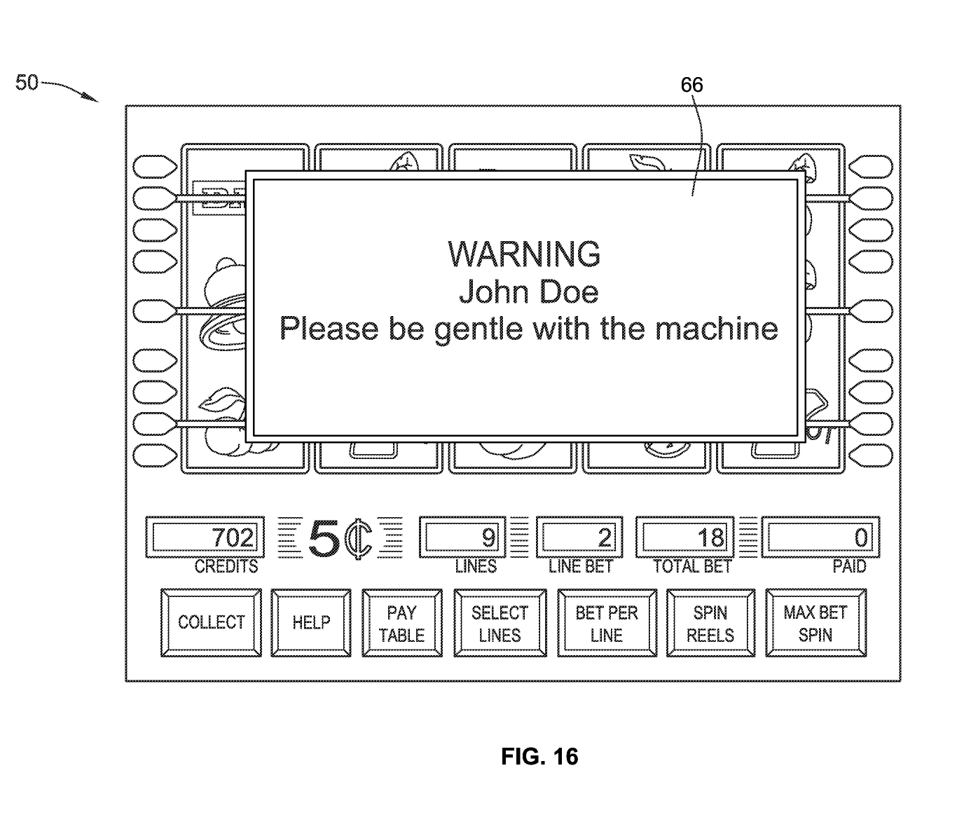

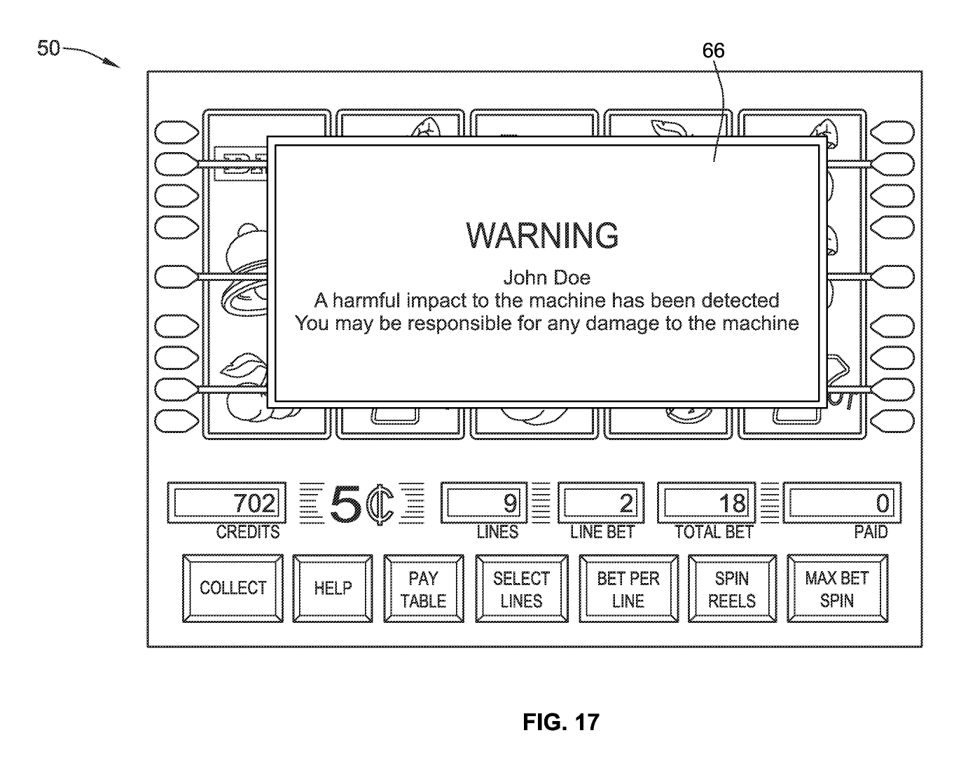

FIG. 16 illustrates an exemplary wagering game screen 50, displayed on the primary display 12, including a response 66 that contains a player's name. FIG. 17 illustrates an exemplary wagering game screen 50, displayed on the primary display 12, including a response 66 further warning the player that he or she may be held responsible for further damage to the gaming terminal 10. Because the player is made aware that the gaming establishment knows his or her identity, the player may be even more influenced to mitigate further harsh handling of the gaming terminal 10.

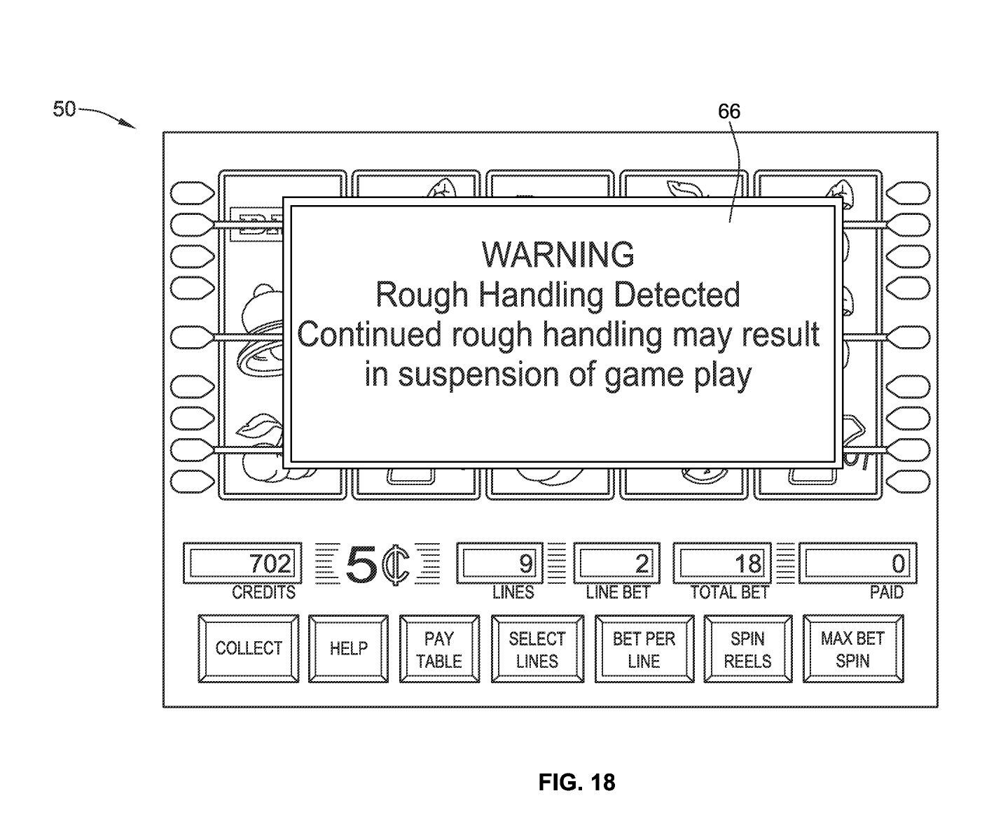

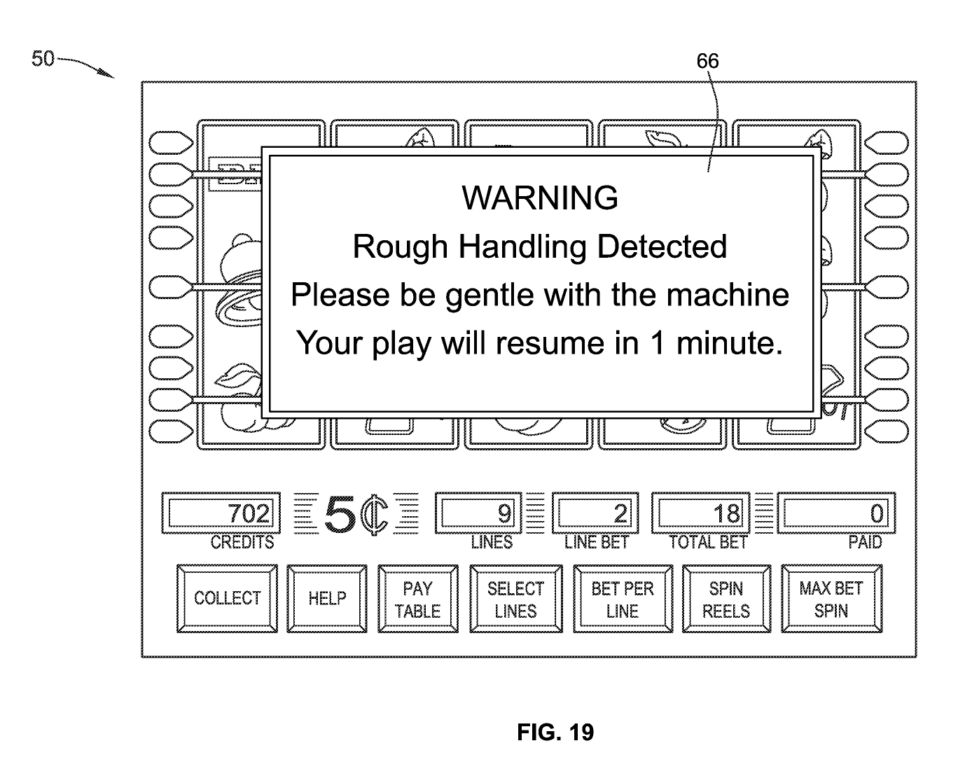

According to some embodiments, the plurality of potential responses can include a gameplay-related consequence and/or a warning of a gameplay-related consequence. For example, the plurality of potential responses can include a suspension of gameplay for a period of time. FIG. 18 illustrates an exemplary wagering game screen 50, displayed on the primary display 12, including a response 66 that provides a warning that “Continued rough handling may result in suspension of gameplay.” FIG. 19 illustrates an exemplary wagering game screen 50, displayed on the primary display 12, including a response 66 indicating that gameplay has been suspended for one minute. Accordingly, the CPU 30 can be configured to prevent initiation of the game until the one minute has expired. It is contemplated that a timer can be provided via one or more of the output devices (e.g., the primary display 12, the secondary display 14, the audio speakers 16, an emotive lighting, a thermal actuator, and/or a haptic actuator) to indicate the time remaining until gameplay may be resumed.

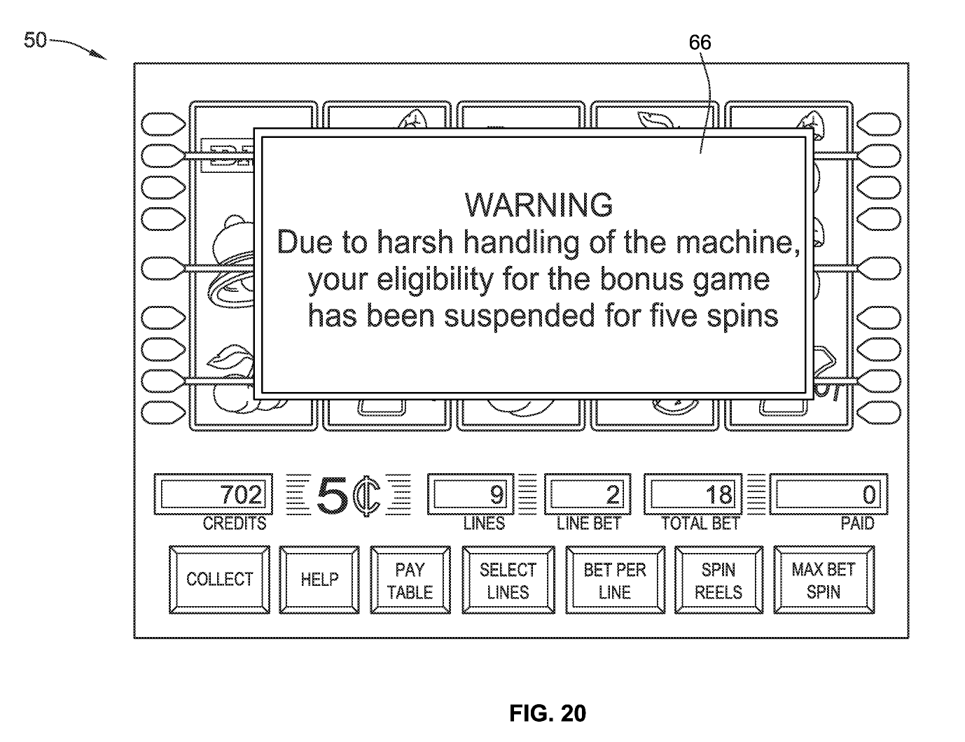

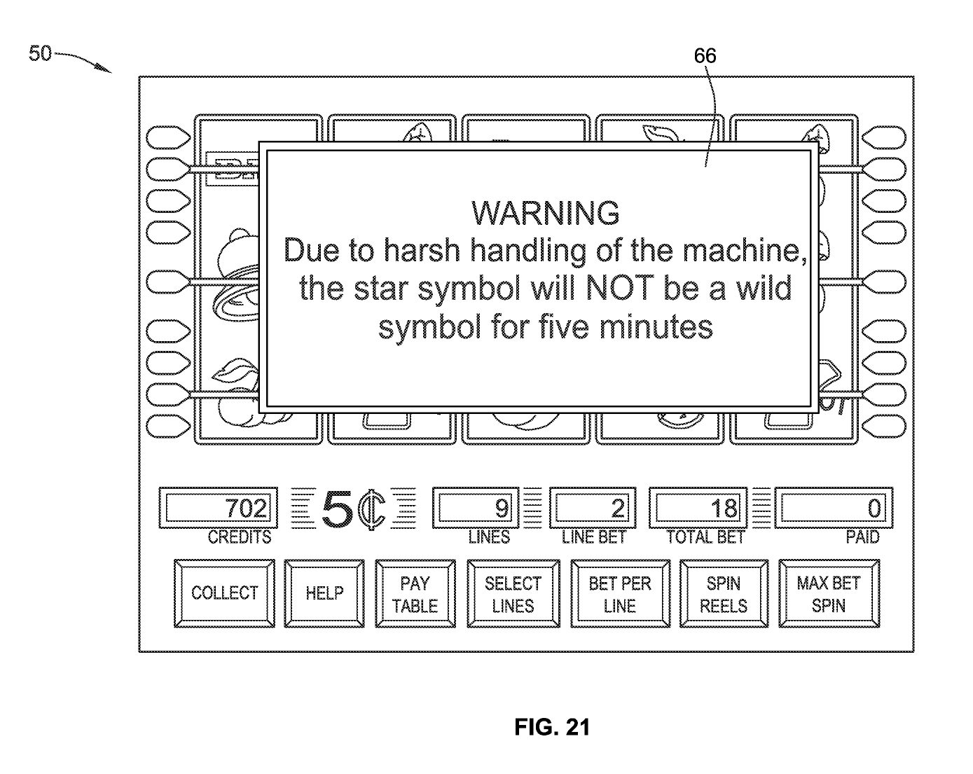

As another example, the plurality of potential responses can include a suspension of or a change to a feature of the game (e.g., eligibility for bonus games, eligibility for certain awards, wild-symbol features, expanding symbol features, multipliers, pay tables, etc.) for a period of time or a number of spins. FIG. 20 illustrates an exemplary wagering game screen 50, displayed on the primary display 12, including a response 66 indicating that the player's eligibility for a bonus game has been suspended for five spins. Accordingly, a player playing a wagering game on the gaming terminal 10 will not be eligible for a bonus game until the sixth spin after receiving the response shown in FIG. 20. FIG. 21 illustrates an exemplary wagering game screen 50, displayed on the primary display 12, including a response 66 indicating that a particular symbol will not be a wild symbol for five minutes. It is also contemplated that a timer or counter can be provided to the player via one or more of the output devices to indicate the time or spins remaining until the feature of the game is reinstated.

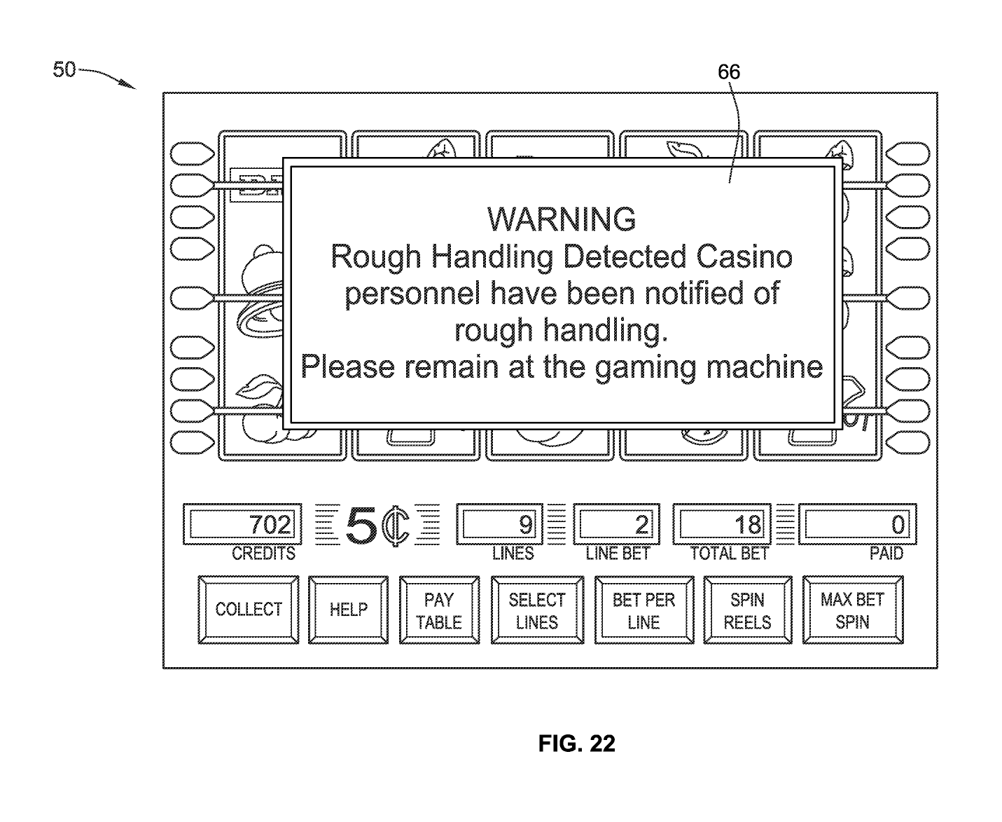

According to some embodiments, the plurality of potential responses can include providing a notification to personnel of a gaming establishment regarding a harsh handling event. For example, the CPU 30 can transmit a signal to the external systems 48 (e.g., a remote server) providing information regarding a harsh handling event. It is contemplated that the information provided to the external systems 48 can include the time and date of an impact, an identification of the gaming terminal 10 impacted, information about the player operating the gaming terminal 10 at the time of the impact, and/or the one or more characteristics obtained from the impact signal (e.g., magnitude, duration, location, etc.). The personnel of a gaming establishment can utilize such information to determine when to more closely monitor a player at the gaming terminal, for example, via a security camera. The personnel of a gaming establishment can also utilize such information to determine when a gaming terminal 10 may require maintenance so as to minimize down time and increase revenue. Additionally, a response to a player can include a notification that casino personnel have been alerted regarding the player's inappropriate handling of a gaming terminal, as shown for example in FIG. 22.

According to some embodiments, the plurality of potential responses can include information based on the status of a wagering game being conducted on the gaming terminal 10. For example, if an impact is detected right after a player wins a jackpot, it may be determined that the impact was the result of the player's excitement at having won the jackpot. A response to such a situation can indicate, for example, “Congratulations on the jackpot but please be careful not to hit the machine too hard.” In such embodiments, it is contemplated that the one or more fault criteria can include information based on the status or other aspects (e.g., achieving a bonus, achieving a jackpot, achieving a free spin, achieving a game asset, achieving a modifier, losing a bonus, losing a jackpot, etc.) of the wagering game being played by a player.

While the exemplary responses illustrated in FIGS. 5-22 include text-based messages displayed on the primary display 12, it should be understood that the responses can be provided by any other output device (e.g., the secondary display 14, the one or more audio speakers 16, an emotive lighting assembly, a thermal actuator, a haptic actuator, combinations thereof, and/or the like). It should also be understood that the plurality of potential responses can include more than one response of the same type and a potential response can include any combination of the different types of responses described above. As a non-limiting example, a set of potential responses may include a first response providing a warning message, a second response providing a threat to suspend gameplay, a third response suspending gameplay, a fourth response providing a warning that casino personnel may be alerted, and a fifth response notifying casino personnel and suspending gameplay.

As described above, the response to an impact is determined from the plurality of potential responses based on an analysis of one or more characteristics of the impact signal with respect to one or more fault criteria. Thus, the gaming terminal 10 is able to dynamically respond to different types of impacts on the gaming terminal 10 to deter further harsh handling by a player. According to some embodiments, the one or more fault criteria can be advantageously configured such that the response that is determined from the plurality of potential responses increases in severity or consequence as the risk for potential harm due to an impact increases. In other words, the greater the risk of harm to a gaming terminal 10 from an impact, the more severe the response to that impact.

In one non-limiting example, a softly worded warning may be provided in response to an impact having a magnitude less than a first threshold value, a more strongly worded warning may be provided in response to an impact having a magnitude greater than the first threshold value and less than a second threshold value, a threat to suspend play may be provided in response to an impact having a magnitude greater than the second threshold value and less than a third threshold value, and gameplay may be suspended in response to an impact having a magnitude greater than the third threshold value. In an exemplary implementation of this non-limiting example, the sensor(s) can be an accelerometer generating an impact signal indicative of a measured g-force, the first threshold value can be 20 g, the second threshold value can be 30 g, and the third threshold value can be 40 g. As another non-limiting example, a warning may be provided in response to a first impact having a magnitude greater than a threshold value, the gameplay may be suspended for a short period of time in response to a second impact having a magnitude greater than the threshold value during the same gaming session, the gameplay may be suspended for a longer period of time in response to a third impact having a magnitude greater than the threshold value during the same gaming session, and casino personnel may be alerted in response to a fourth impact having a magnitude greater than the threshold value during the gaming session.

It also should be understood that a potential response can be associated with more than one of the fault criteria. For example, a first response may be provided in response to an impact having a magnitude above a first threshold value, the first response may also be provided in response to an impact having a magnitude above a second threshold value for a duration that is less than a third threshold value, and a second response may be provided in response to an impact having a magnitude above the second threshold value for a duration above the third threshold value. Additionally, it is contemplated that, according to some embodiments that include a plurality of sensors 60a-d, the impact signals from each of the plurality of sensors 60a-d can be evaluated with a different set of one or more fault criteria to account for the different structural and damping considerations due to the different locations of the sensors throughout the gaming terminal 10. It is further contemplated that the CPU or other signal processing components can be configured to process multiple impact signals relating to the same harsh handling event.

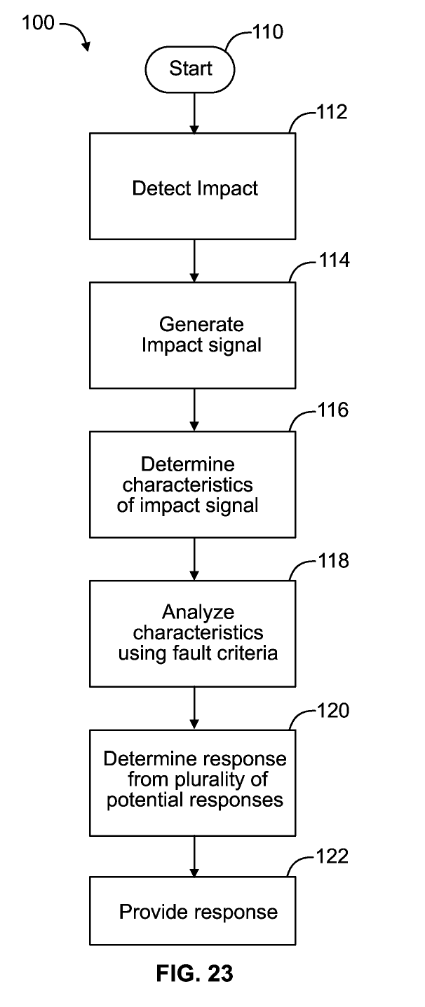

Referring now to FIG. 23, an exemplary flowchart of a process 100 for detecting and responding to an impact or external force on a gaming terminal is illustrated. At block 110, the process is initiated. At block 112, an impact is detected, for example, by a sensor. At block 114, an impact signal is generated. At block 116, one or more characteristics of the impact signal are determined. At block 118, the one or more characteristics are analyzed using one or more fault criteria. At block 120, a response is determined from a plurality of potential responses based on the analysis at block 118. At block 122, the response determined for the detected impact is provided to the player and/or otherwise executed. In some embodiments, the process 100 includes at least those steps enumerated above. It is also within the scope and spirit of the present invention to omit steps, include additional steps, and/or modify the order presented above.

Each of these embodiments and obvious variations thereof is contemplated as falling within the spirit and scope of the claimed invention, which is set forth in the following claims.

What is claimed is:

1. A gaming terminal, comprising:
one or more output devices configured to provide at least one of an audio output and a visual output to a user of the gaming terminal;
one or more sensor devices configured to measure an impact on the gaming terminal and generate an impact signal indicative of the measured impact; and
one or more processors in communication with the one or more output devices and the one or more sensor devices, the one or more processors being operable to:
receive the impact signal from the one or more sensors;
determine a response from a plurality of potential responses based on the impact signal; and
cause the one or more output devices to provide at least one of the audio output and the visual output according to the determined response.

2. The gaming terminal according to claim 1, wherein the one or more output devices comprise a display and the sensor is configured to measure the impact on the display.

3. The gaming terminal according to claim 1, wherein the one more processors are operable to determine the response from the plurality of potential responses based on the impact signal by being operable to:
determine one or more characteristics of the impact signal; and
compare the one or more characteristics of the impact signal to one or more fault criteria.

4. The gaming terminal according to claim 3, wherein the one or more fault criteria include one or more threshold values.

5. The gaming terminal according to claim 3, wherein the one or more fault criteria include one or more predetermined impact signatures.

6. The gaming terminal of claim 1, wherein the plurality of potential responses includes a warning message.

7. The gaming terminal according to claim 1, wherein the plurality of potential responses includes an indication that play of a wagering game has been suspended.

8. The gaming terminal according to claim 1, wherein the plurality of potential responses includes an indication than a feature of a wagering game has been suspended.

9. The gaming terminal according to claim 8, wherein the feature of the wagering game includes eligibility to participate in a bonus game.

10. The gaming terminal according to claim 8, wherein the feature of the wagering game includes eligibility to achieve a progressive award.

11. The gaming terminal according to claim 8, wherein the feature of the wagering game is a wild-symbol.

12. The gaming terminal according to claim 1, further comprising an information reader configured to obtain user information from a user of the gaming terminal, the plurality of potential responses including an indication of the user information.

13. The gaming terminal according to claim 1, wherein the one or more sensors includes an accelerometer.

14. A method of detecting and responding to an impact on a gaming terminal, comprising:
detecting, by one or more sensor devices, an impact on a gaming terminal;
determining, by one or more processors, one or more characteristics of the detected impact;
comparing, by at least one of the one or more processors, the one or more characteristics to one or more fault criteria;
determining, by at least one of the one or more processors, a response from a plurality of potential responses based on the comparison of the one or more characteristics to the one or more fault criteria; and
providing, via one or more output devices, the determined response to a player of the wagering game.

15. The method according to claim 14, wherein the one or more characteristics include at least one of a magnitude of an impact, a duration of an impact, and a location of an impact.

16. The method according to claim 14, wherein the one or more fault criteria include at least one threshold value.

17. The method according to claim 14, wherein the one or more characteristics of the impact signal comprise a signature of the impact and the one or more fault criteria include at least one predetermined impact signature.

18. The method according to claim 14, further comprising:
conducting a wagering game on the gaming terminal; and
in response to the determining a response, suspending the conducting of the wagering game for a period of time.

19. The method according to claim 14, further comprising:
conducting a wagering game on the gaming terminal; and
in response to the determining a response, suspending a feature of the wagering game for a number of spins.

20. The method according to claim 14, wherein the plurality of potential responses includes an indication of a location on the gaming terminal for the impact.

21. The method according to claim 14, wherein the plurality of potential responses includes an indication of a number of impacts on the gaming terminal.

22. The method according to claim 14, further comprising notifying casino personnel of the impact.

23. The method according to claim 14, wherein the plurality of potential responses have increasing levels of severity and the one or more fault criteria are configured such that the level of severity of the determined response increases as a likelihood of harm to a gaming terminal from the detected impact increases.

24. A gaming system, comprising:
a gaming terminal including:
one or more sensor devices configured to measure an impact on the gaming terminal and generate an impact signal indicative of the measured impact, and
one or more processors in communication with the one or more sensor devices, the one or more processors being operable to:
receive the impact signal from the one or more sensors;
determine a response from a plurality of potential responses based on the impact signal; and
cause the determined response to be provided to a player of the gaming terminal; and
a server in communication with the gaming terminal, the server being operable to receive information based on the impact signal from the gaming terminal.
